(19) United States
(12) Patent Application Publication
(10) Pub. No.: US 2020/0082320 A1
(43) Pub. Date: Mar. 12, 2020

(54) WIRE HARNESS ASSEMBLY WORK INSTRUCTION DEVICE, AND WIRE HARNESS ASSEMBLY WORK INSTRUCTION METHOD

(71) Applicant: Mitsubishi Electric Corporation, Chiyoda-ku, Tokyo (JP)

(72) Inventor: Mizuki TSUNODA, Chiyoda-ku, Tokyo (JP)

(73) Assignee: Mitsubishi Electric Corporation, Chiyoda-ku, Tokyo (JP)

(21) Appl. No.: 16/609,581

(22) PCT Filed: May 15, 2018
(86) PCT No.: PCT/JP2018/018733

§ 371 Date: Oct. 30, 2019

(30) Foreign Application Priority Data
Jun. 5, 2017 (JP) 2017-110722

(51) Int. Cl. G06Q 10/06; G06Q 50/04

(52) U.S. Cl. CPC G06Q 10/063114; G06Q 50/04

(57) ABSTRACT

A wire harness assembly work instruction device includes: a placement display for displaying an actual-size image of a wire harness in an overlapping manner; a product specification information storage unit for storing specifications of components, and a wiring order; a display unit for displaying the specifications of the components and the wiring order; a skill information storage unit for storing, for individual assembly workers, skill information; a production record storage unit for storing presence/absence of a production record of the wire harness; a worker information input unit for inputting information for identifying each worker; and a work instruction calculation unit for providing an instruction about the wiring order in accordance with skill information about each worker stored in the skill information storage unit.

### TECHNICAL FIELD

The present disclosure relates to a wire harness assembly work instruction device and a wire harness assembly work instruction method for providing instructions for assembling a wire harness by a display.

### BACKGROUND ART

As an example of conventional wire harness assembly work instruction devices, a device is proposed which projects and displays a product shape on a screen in front of a workbench in order to provide instructions about product arrangements to a worker (see, for example, Patent Document 1).

### CITATION LIST

### Patent Document

Patent Document 1: Japanese Laid-Open Patent Publication No. 2007-323831 (page 13, lines 32 to 37, and FIG. 2)

### SUMMARY OF THE INVENTION

### Problems to be Solved by the Invention

In such a wire harness assembly work instruction device, when checking wiring paths and dimensions displayed on the front screen with a wire harness during assembly work, the dimensions of the wire harness during assembly work need to be measured for each time, thus causing a problem that workability is low. In addition, in the case where a non-skilled person performs assembly work for a wire harness, the non-skilled person cannot figure out a specific wiring order from only information needed for a skilled person, and it is necessary to provide instructions about the wiring order separately, thus causing a problem that workability is low.

The present disclosure has been made to solve the above problems, and an object of the present disclosure is to provide a wire harness assembly work instruction device and a wire harness assembly work instruction method that eliminate the need of measuring the dimensions of a wire harness during assembly work for each time and allow both of a skilled person and a non-skilled person to assemble a wire harness with only displayed work instructions.

### Solution to the Problems

A wire harness assembly work instruction device according to the present disclosure includes: a placement display for displaying an image of a wire harness in an overlapping manner on a workbench; a product specification information storage unit for storing specifications of components for forming the wire harness, and a predetermined wiring order at a time when the wire harness has been assembled; a display unit for displaying the specifications of the components and the wiring order stored in the product specification information storage unit; a skill information storage unit for storing, for individual assembly workers, skill information about the workers; a production record storage unit for storing presence/absence of a production record of the wire harness; a worker information input unit for inputting information for identifying each worker; and a work instruction calculation unit for providing an instruction about the wiring order in accordance with skill information about each worker stored in the skill information storage unit.

A wire harness assembly work instruction method according to the present disclosure is a wire harness assembly work instruction method using the above wire harness assembly work instruction device in which the product specification information storage unit includes: a wire number for uniquely identifying each of a plurality of electric wire to be used for the wire harness; an electric wire type name of each electric wire; a wire length of each electric wire; a type number of a first connection destination to which one end of each electric wire is to be connected; and a type number of a second connection destination to which another end of each electric wire is to be connected. The wire harness assembly work instruction method include: an electric wire cutting step of cutting, at the wire length, each of the plurality of electric wires indicated by the electric wire type names, as displayed on the display unit; terminal preparing step of preparing a necessary number of terminals of the first connection destination and the second connection destination indicated by the product specification information storage unit, as displayed on the display unit; a tool preparing step of preparing tools corresponding to connections between the terminals and the electric wires indicated by the electric wire type names, as displayed on the display unit; a terminal connection step of making connections between the electric wires and the terminals by using the tools; and a wiring binding step of laying the plurality of the electric wires to which the terminals have been attached, on the image displayed on the placement display, and binding the electric wires at a position displayed on the image.

### Effect of the Invention

With the wire harness assembly work instruction device and the wire harness assembly work instruction method according to the present disclosure, it is not necessary to measure the dimensions of a wire harness during assembly work for each time, and thus work efficiency is improved. In addition, it becomes possible for both a skilled person and a non-skilled person to assemble a wire harness with only displayed work instructions. In addition, the work records of skilled persons are accumulated, whereby it becomes possible to indicate a wiring order based on the work records, to a non-skilled person.

### BRIEF DESCRIPTION OF THE DRAWINGS

FIG. 1 shows the hardware configuration of a wire harness assembly work instruction device according to embodiment 1.

FIG. 2 shows the details of an electric wire holder according to embodiment 1.

FIG. 3 is a block diagram showing the software configuration of the wire harness assembly work instruction device according to embodiment 1.

FIGS. 4A-4D show a process for determining a start order for assembling wire harnesses according to embodiment 1.

FIG. 5A-5D show the procedure for generating a work instruction by a work instruction calculation unit according to embodiment 1.

FIG. 6 is a flowchart of assembly work for a wire harness according to embodiment 1.

### DESCRIPTION OF EMBODIMENTS

### Embodiment 1

Hereinafter, a wire harness assembly work instruction device according to embodiment 1 will be described with reference to the drawings.

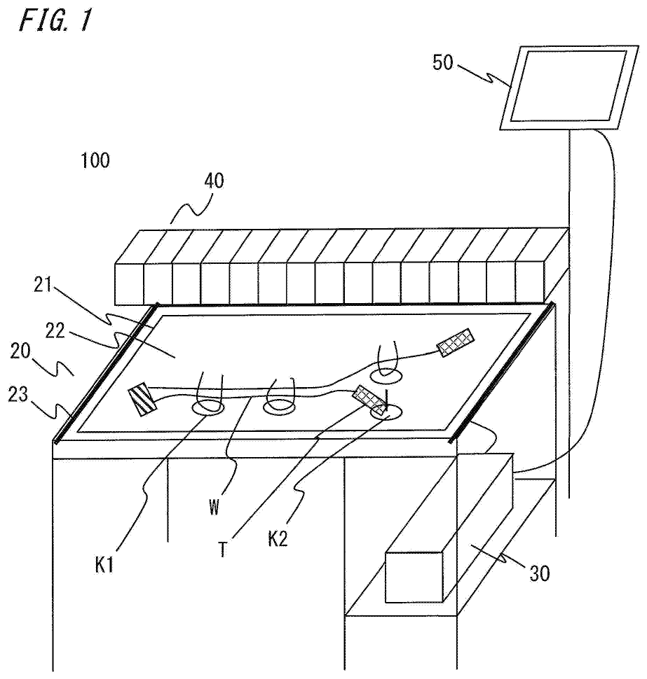

FIG. 1 shows the hardware configuration of a wire harness assembly work instruction device 100 (hereinafter, simply referred to as a work instruction device 100).

The work instruction device 100 includes: a workbench 20; a computing device 30 provided under the workbench 20; a touch panel display 50 (display unit) for displaying work instruction information to a worker and receiving input of a work result; and an electric wire holder 40 for catching a cut electric wire to be used for assembling a wire harness.

The workbench 20 includes: a placement display 21 for displaying an actual-size image of a finished-product wire harness which is to be assembled from now, in an overlapping manner under components for forming the product, during work; an acrylic plate 22 for protecting the placement display 21; and rails 23 for sliding and moving the electric wire holder 40 on the placement display 21. The position of the electric wire holder 40 is movable as appropriate in accordance with a product to be assembled.

The placement display 21 is formed from a liquid crystal display, and is required to have such a size that, by a single unit, allows an entire wire harness to be displayed thereon, in order to display an actual-size image of a finished-product wire harness. In the case of using a display having a size that does not allow the entire wire harness to be displayed by a single display, a plurality of displays having the same size are combined to have a size that allows the entire finished-product wire harness to be displayed.

It is noted that the placement display 21 may be a display having a touch panel function and a work result may be displayed on the placement display 21, whereby assembly work can be performed in the same manner without the touch panel display 50.

The rails 23 are formed by coating steel pipes with plastic by adhesion, and are connected to the electric wire holder 40 via iron joints that are slidable on the pipes.

A sucker-equipped clip K1 is used to lay and fix an electric wire W on the acrylic plate 22, and a sucker-equipped pin K2 is used to fix a crimp terminal T to the acrylic plate 92

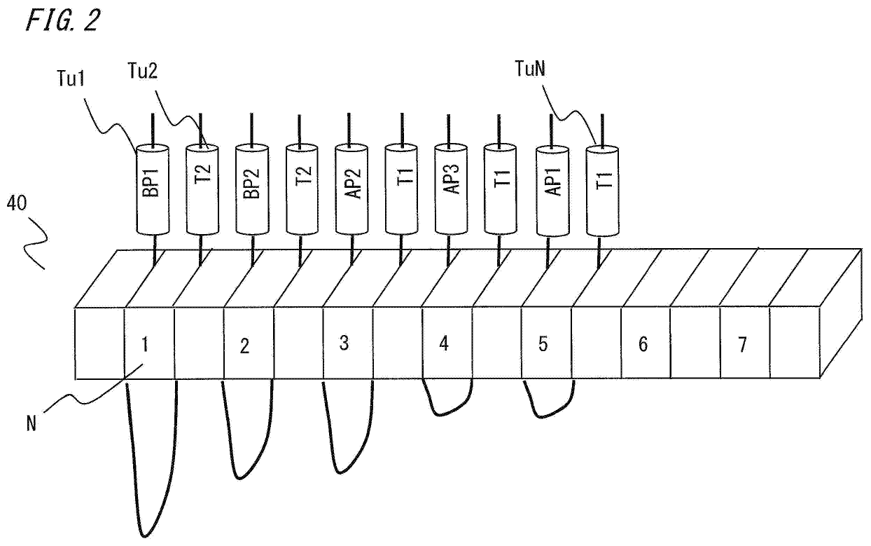

FIG. 2 shows the details of the electric wire holder 40.

The electric wire holder 40 is for fixing electric wires to be used for assembling a wire harness by catching the electric wires, and is made from a sponge material so as not to damage the coating on the surface of each electric wire or the internal core wire.

In addition, the electric wire holder 40 has slits formed at regular intervals for catching the electric wires therein. One electric wire is caught in two slits such that both ends of the electric wire are directed upward. Since only one end of each electric wire is caught in one slit, as shown in FIG. 2, the electric wire holder 40 has electric wire numbers N at every other location between the adjacent slits. The details of the way of using the electric wire holder 40 will be described later.

The placement display 21 and the touch panel display 50 are connected to the computing device 30 provided under the workbench 20. An actual-size image of a finished-product wire harness is to be displayed on the placement display 21. A product assembly work is performed with components placed in an overlapping manner on the wire harness image. Thus, it is possible to perform wire harness assembly work without the need of measuring the dimensions of the electric wire during assembling.

It is necessary to fix the electric wire W and the like during assembling in order to perform wire harness assembly work in an overlapping manner on the wire harness image displayed on the placement display 21. Therefore, the electric wire W is fixed to the acrylic plate 22 by using the sucker-equipped clip K1 and the sucker-equipped pin K2 on the acrylic plate 22.

The sucker-equipped clip K1 is for fixing the electric wire W by clipping. The sucker-equipped pin K2 is for making fixation by inserting the pin into a screw fastening hole of the end of the crimp terminal T so as to be engaged. The sucker-equipped clip K1 has a sponge material attached inside so as not to damage the coating on the surface of the electric wire W or the internal core wire when lipping the electric wire W.

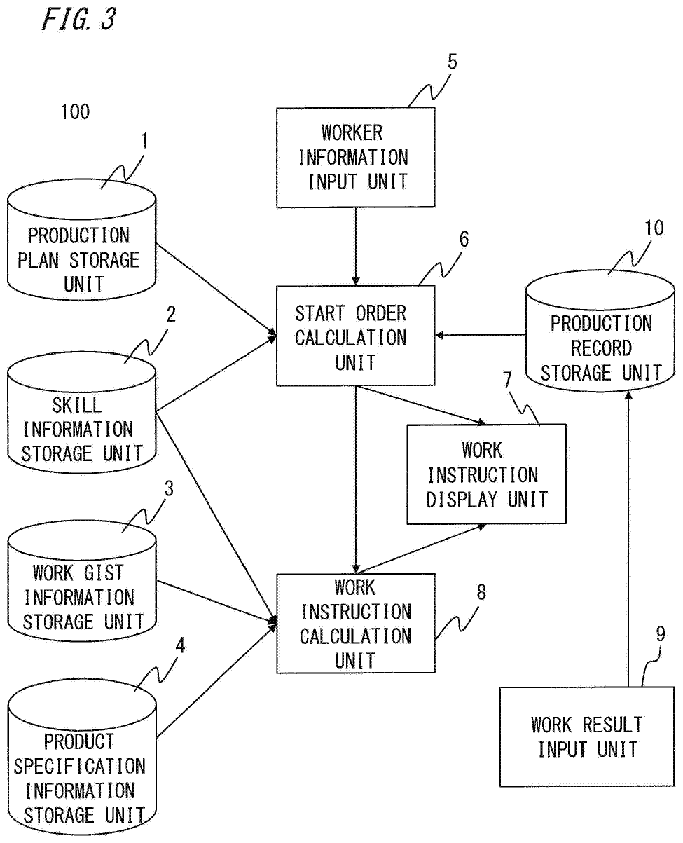

FIG. 3 is a block diagram showing a software configuration and processes in the work instruction device 100.

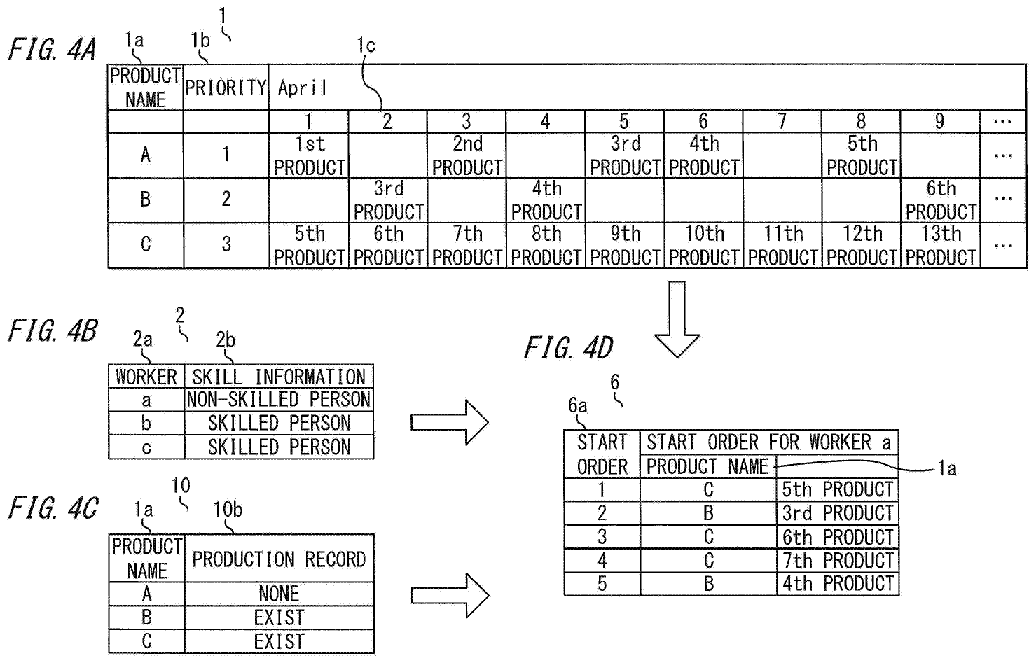

FIG. 4 shows a process for determining a start order for assembling wire harnesses.

The work instruction device 100 includes a production plan storage unit 1, a skill information storage unit 2, a work gist information storage unit 3, a product specification information storage unit 4, a worker information input unit 5, a start order calculation unit 6, a work instruction display unit 7, a work instruction calculation unit 8, a work result input unit 9, and a production record storage unit 10.

FIG. 4A shows the configuration of the production plan storage unit 1. As an example, a production plan for individual products in April is shown.

The production plan storage unit 1 stores a product name 1a, a priority 1b of production of each product, and a scheduled start date 1c, as a production plan for products to be produced. Here, it is indicated that one wire harness is produced on each scheduled start date 1c. However, in actuality, a considerable number of wire harnesses are to be produced.

FIG. 4B shows the configuration of the skill information storage unit 2.

FIG. 4C shows the configuration of the production record storage unit 10.

The skill information storage unit 2 stores skill information 2b for each worker 2a inputted by the worker information input unit 5. In the skill information 2b, classification of a “skilled person” or a “non-skilled person” is stored. The production record storage unit 10 stores information about whether or not a production record 10b exists for each product name 1a. In the case of a new product, “None” is indicated. A skilled person is defined as being able to assemble all the products shown in the production plan, and a non-skilled person is defined as being able to assemble only products for which a skilled person has ever assembled the same products and for which the production record 10b in the production record storage unit 10 indicates “Exist”. It is noted that the skill information 2b of the workers 2a may be classified in more detail.

FIG. 4D shows the product names 1a of products for which a specific worker a starts assembling, and a start order 6a thereof.

The start order calculation unit 6 calculates the product names 1a and the start order 6a of products to be produced by each worker 2a, on the basis of: information about workers inputted from the worker information input unit 5; the skill information 2b about each worker 2a stored in the skill information storage unit 2; information about whether or not the production record 10b for each product exists, which is stored in the production record storage unit 10; the priority 1b of production of each product stored in the production plan storage unit 1; and the scheduled start date 1c of each product.

Specifically, first, on the basis of the ID of a worker inputted from the worker information input unit 5, the worker 2a corresponding to the ID and the skill information 2b of the worker 2a are searched for in the skill information storage unit 2, to extract the skill information 2b about the worker 2a associated with the ID of the worker 2a that is inputted.

In the case where the skill information 2b about the worker 2a that is inputted indicates “non-skilled person”, each product of the product names 1a in the production plan storage unit 1 is checked for whether or not the production record 10b of the product of the product name 1a exists in the production record storage unit 10 shown in FIG. 4C. Then, from among only the products for which the production records exist, assignment is performed for the start order 6a shown in FIG. 4D sequentially from the earliest one of the scheduled start dates 1c stored in the production plan storage unit 1. In the case where there are a plurality of products having the same scheduled start date 1c, the product having the higher priority 1b is preferentially assigned for the start order 6a. In the case where there are identical products having the same scheduled start date 1c, they are assigned for the start order 6a sequentially from the smallest product number.

In the case where the skill information 2b about the worker 2a indicates “skilled person”, the worker 2a is able to undertake production of all the products. Therefore, the products are assigned for the start order 6a shown in FIG. 4D sequentially from the earliest one of the scheduled start dates 1c stored in the production plan storage unit 1.

The work instruction display unit 7 displays the calculated start order 6a on the touch panel display 50, and information about the product name having the earliest rank in the start order 6a of assembly work and the number of products to be produced are sent to the work instruction calculation unit 8.

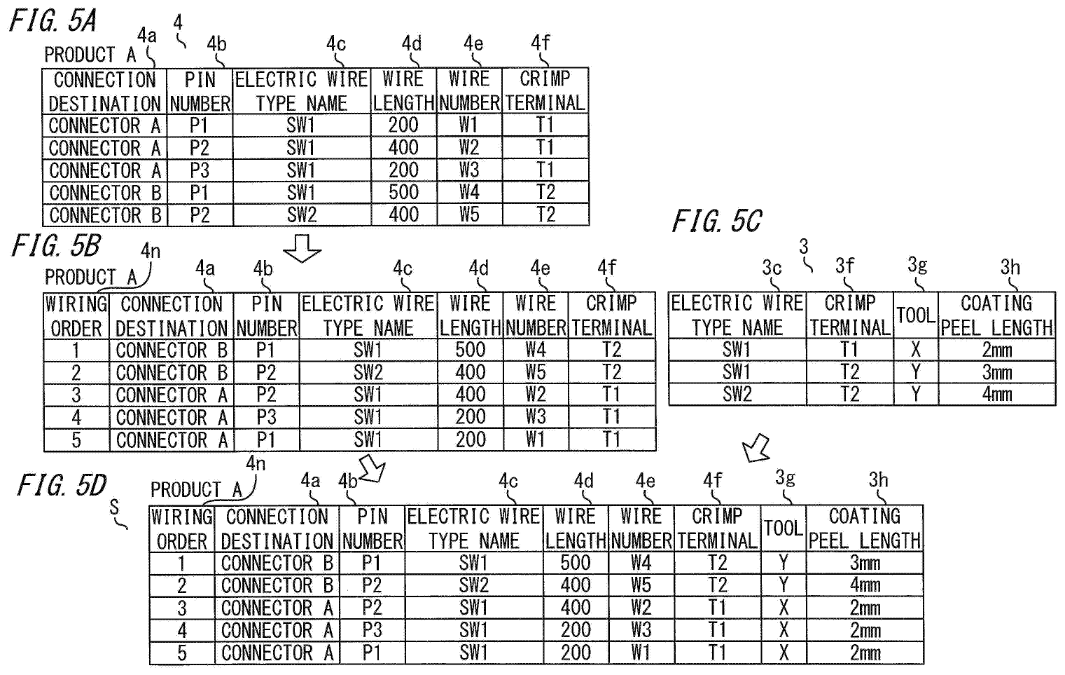

FIG. 5 shows the procedure for generating a work instruction S by the work instruction calculation unit 8.

The work instruction calculation unit 8 calculates a work instruction S for the product having the earliest rank in the start order calculated by the start order calculation unit 6, on the basis of information from the work gist information storage unit 3, the product specification information storage unit 4, and the production record storage unit 10.

FIG. 5A shows the specifications of components constituting a product A, which are stored in the product specification information storage unit 4, in the case where the product A is a product for which production is to be newly started from now. For discrimination among products, they may be classified using file names. In FIG. 5A, the following information is stored: a wire number 4e for uniquely identifying each of electric wires W to be used for the product A, an electric wire type name 4c of each electric wire W, a wire length 4d of each electric wire W, a type number of a connection destination 4a (first connection destination) of one end of each electric wire, a pin number 4b of the connection destination and a type number of a crimp terminal 4f (second connection destination) which is a connection destination of the other end. In FIG. 5A, connectors that are terminals are exemplified as the connection destinations 4a. A connector (terminal) may be connected also on the crimp terminal 4f side and a pin number thereof may be stored. It is found that the product A is composed of five wires of which the wire numbers 4e are W1 to W5, two types of connectors as the connection destinations 4a, and two types of crimp terminals 4f.

FIG. 5B shows the configuration of the product A stored in the product specification information storage unit 4 in the case where the product A is an existing product.

For the existing product, a product for which the “production record” in the production record storage unit 10 shown in FIG. 4C indicates “Exist”, the product specification information storage unit 4 includes data of a wiring order 4n of electric wires wired when the first worker assembled the production as shown in FIG. 5B, in addition to the information shown in FIG. 5A.

FIG. 5C shows the configuration of the work gist information storage unit 3.

The work gist information storage unit 3 stores in advance a combination of each electric wire type name 3c and a type number of a crimp terminal 3f to be used therefor, a type name of a tool 3g to be used for attaching the crimp terminal 3f, and a coating peel length 3h which is a length by which the insulation coating at the end of the electric wire is to be removed to expose the core wire at the end.

FIG. 5D shows the configuration of the work instruction S.

The work instruction calculation unit 8 checks a combination of the crimp terminal 4f and the electric wire type name 4c of each one of the electric wires W1 to W5 to be used for producing the wire harness product A, stored in the product specification information storage unit 4, with a combination of the crimp terminal 3f and the electric wire type name 3c stored in the work gist information storage unit 3 shown in FIG. 5C, and extracts the tool 3g and the coating peel length 3h corresponding to the matched combination. The information about the tool 3g and the coating peel length 3h that are extracted is merged with the information shown in FIG. 5B, whereby the work instruction S for each one of the electric wires W1 to W5 is generated.

The work instruction display unit 7 displays, on the touch panel display 50, the work instruction S for the product name 1a for which assembly work is to be performed, calculated by the work instruction calculation unit 8.

The worker 2a performs wiring work in accordance with the wiring order 4n (or in accordance with the worker's determination if the wiring order 4n is not stored). Then, when the work is finished, the worker 2a inputs the fact that the assembly work is finished, through the work result input unit 9. The inputted information is sent to the production record storage unit 10, and the production record 10b is updated for each product.

If the product that has been assembled is the first one for this type of product, the order in which the assembly work has been conducted on a wire-by-wire basis is to be stored as the wiring order 4n into the product specification information storage unit 4.

Next, the procedure for assembling a wire harness will be described with reference to the drawings.

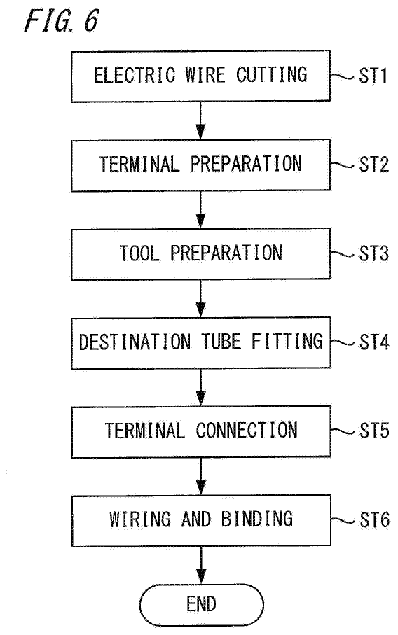

FIG. 6 shows a flowchart of assembly work for a wire harness.

The assembly work for the wire harness includes six steps, and predetermined information can be displayed on the touch panel display 50 on a step-by-step basis so as to be provided to the worker 2a.

An electric wire cutting step (ST1) is a step of, for each product, cutting an electric wire indicated by the electric wire type name 4c at a length indicated by the wire length 4d. In this step, only the wiring order 4n, the electric wire type name 4c, and the wire length 4d in the product specification information storage unit 4 are displayed as a list on the touch panel display 50. Each cut electric wire is caused to be caught in the electric wire holder 40 as shown in FIG. 2. In the case where the wiring order is stored, the electric wires are caused to be caught in the stored wiring order at predetermined positions in the electric wire holder 40. In the case where the wiring order is not stored, the electric wires are caused to be caught in the order from the top one displayed on the touch panel display 50.

A terminal preparing step (ST2) is a step of preparing a necessary number of crimp terminals indicated in the product specifications. The type names and the numbers of crimp terminals 4f needed for the product to be assembled from now are extracted from the product specification information storage unit 4, the necessary number is counted for each type name, and a result thereof is displayed on the touch panel display 50.

A tool preparing step (ST3) is a step of preparing tools needed for assembly work for the product to be assembled from now. The type names of the tools 3g included in the work instruction S calculated by the work instruction calculation unit 8 are all extracted, repetition of the same type name is eliminated, and a result thereof is displayed as a list on the touch panel display 50.

A destination tube fitting step (ST4) is a step of fitting vinyl tubes on which connection destinations are written, to both ends of each electric wire in order to allow discrimination of the connection destinations of the electric wires. The correspondence relationship between the electric wire numbers N on the electric wire holder 40 and characters written on the tubes to be fitted is displayed as a list on the touch panel display 50.

As used herein, the “electric wire number N” is different from the “wire number 4e” provided when newly registering a product in the product specification information storage unit 4. The wire number 4e is a number provisionally provided for identifying an electric wire needed for assembling a product at the time of registering the product name 1a.

FIG. 2 shows a state in which destination tubes Tu1 to TuN are fitted to five electric wires caught in the electric wire holder 40 on the basis of the work instruction S shown in FIG. 5D. The destination tube Tu1 on which “BP1” is written as a destination is fitted to one end of the electric wire at the electric wire number 1. This indicates that the destination to which the one end is to be connected is a pin number P1 of a connector B. The destination tube Tu2 on which T2 is written is fitted to the other end. This indicates that the destination to which the other end is to be connected is a crimp terminal T2. By causing each electric wire to be caught in the electric wire holder 40 such that both ends of the electric wire are directed upward, it is possible to attach the destination tubes Tu1 to TuN to the electric wires in a state in which the electric wires are caught in the electric wire holder 40.

A terminal connection step (ST5) is a step of removing a coating at an end of the electric wire by the coating peel length 3h indicated for a combination of the electric wire type name 4c and the crimp terminal 4f in the work instruction S, setting the crimp terminal 4f at the end from which the coating has been removed, and connecting the end of the electric wire to the crimp terminal 4f by crimping, using the tool 3g designated for the crimp terminal 4f.

In this step, since the work instruction S is displayed on the touch panel display 50, the worker 2a sequentially crimps each required crimp terminal 4f using the designated tool 3g while confirming the display and the indication written on the destination tube caught at the electric wire holder 40.

In the above description, removal of a coating at a part other than an end to be connected to the crimp terminal 4f has not been mentioned. However, in the work gist information storage unit 3, columns for connectors may be added and coating peel lengths therefor may be added, whereby processing can be performed in the same manner as described above.

A wiring binding step (ST6) is a step of performing arrangement and connection of connectors and wiring and binding as a wire harness. First, the work instruction S displayed in the terminal connection step (ST5) is displayed on the touch panel display 50. In addition, an actual-size image of a finished product of the wire harness during the assembly work is displayed on the placement display 21.

Images of finished products of wire harnesses are also stored on a product basis in the product specification information storage unit 4. The images of the finished products are obtained by converting 3-dimensional data into plane data. The corresponding image is displayed in an actual size on the placement display 21, and the real connector is laid on the connector image. Next, each crimp terminal 4f is fixed to the sucker-equipped pin K2. Next, each electric wire is caused to creep in an overlapping manner on the image and is fixed using the sucker-equipped clip K1. Next, an end of a predetermined electric wire is connected to a designated pin of a designated connector. Next, the electric wires are bound at a binding belt position on the image.

In this way, by confirming binding positions and bending positions of electric wires on the basis of the image displayed under the components, it is possible to produce a wire harness in accordance with the product specifications.

The wire harness assembly work instruction device and the wire harness assembly work instruction method according to embodiment 1 eliminate the need of measuring the dimensions of a wire harness during assembly work for each time, and allow both of a skilled person and a non-skilled person to assemble a wire harness with only displayed work instructions. In addition, the work records of skilled persons are accumulated, whereby it becomes possible to indicate a wiring order based on the work records, to a non-skilled person.

Although the disclosure is described above in terms of an exemplary embodiment, it should be understood that the various features, aspects and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

100 wire harness assembly work instruction device

1 production plan storage unit

2 skill information storage unit

1a product name

1b priority

1c scheduled start date

2a worker

2b skill information

3 work gist information storage unit

3c electric wire type name

3f crimp terminal

3g tool

3h coating peel length

4 product specification information storage unit

4a connection destination

4b pin number

4c electric wire type name

4d wire length

4e wire number

4f crimp terminal

4n wiring order

5 worker information input unit

6 start order calculation unit

6a start order

7 work instruction display unit

8 work instruction calculation unit

9 work result input unit

10 production record storage unit

10b production record

20 workbench

21 placement display

22 acrylic plate

23 rail

30 computing device

40 electric wire holder

50 touch panel display

N electric wire number

S work instruction

T crimp terminal

W electric wire

K1 sucker-equipped clip

K2 sucker-equipped pin

P1 pin number

T2 crimp terminal

W1 to W5 electric wire

Tu1, Tu2 destination tube

1. A wire harness assembly work instruction device comprising:
a placement display for displaying an image of a wire harness in an overlapping manner on a workbench;
a product specification information storage unit for storing specifications of components for forming the wire harness, and a predetermined wiring order at a time when the wire harness has been assembled;
a display unit for displaying the specifications of the components and the wiring order stored in the product specification information storage unit;
a skill information storage unit for storing, for individual assembly worker skill information about the workers;
a production record storage unit for storing presence/absence of a production record of the wire harness;
a worker information input unit for inputting information for identifying each worker; and
a work instruction calculation unit for providing an instruction about the wiring order in accordance with skill information about each worker stored in the skill information storage unit.

2. The wire harness assembly work instruction device according to claim 1, wherein
the specifications of the components in the product specification information storage unit include: a wire number for uniquely identifying each of a plurality of electric wires to be used for the wire harness; an electric wire type name of each electric wire; a wire length of each electric wire; a type number of a first connection destination to which one end of each electric wire is to be connected; and a type number of a second connection destination to which another end of each electric wire is to be connected.

3. The wire harness assembly work instruction device according to claim 2, further comprising a work gist information storage unit storing a type number of at least one of: a tool corresponding to a combination of the electric wire type name and the type number of the first connection destination; and a tool corresponding to a combination of the electric wire type name and the type number of the second connection destination.

4. The wire harness assembly work instruction device according to claim 3, wherein
the work gist information storage unit further stores at least one of: a coating peel length corresponding to a combination of the electric wire type name, the type number of the first connection destination, and the corresponding tool; and a coating peel length corresponding to a combination of the electric wire type name, the type number of the second connection destination, and the corresponding tool, and
the coating peel length defines a range in which an insulating coating is to be removed at an end of the electric wire.

5. A wire harness assembly work instruction method using the wire harness assembly work instruction device according to claim 2, the wire harness assembly work instruction method comprising:
an electric wire cutting step of cutting, at the wire length, each of the plurality of electric wires indicated by the electric wire type names, as displayed on the display unit;
a terminal preparing step of preparing a necessary number of terminals of the first connection destination and the second connection destination indicated by the product specification information storage unit, as displayed on the display unit;
a tool preparing step of preparing tools corresponding to connections between the terminals and the electric wires indicated by the electric wire type names, as displayed on the display unit;
a terminal connection step of making connections between the electric wires and the terminals by using the tools; and
a wiring binding step of laying the plurality of the electric wires to which the terminals have been attached, on the image displayed on the placement display, and binding the electric wires at a position displayed on the image.

6. The wire harness assembly work instruction method according to claim 5, further comprising, after the electric wire cutting step, a destination tube fitting step of causing the electric wires to be caught in an electric wire holder in the wiring order such that both ends of each electric wire are directed upward, and fitting, to the respective ends of each electric wire, tubes on which connection destinations of the ends are recorded.

7. The wire harness assembly work instruction method according to claim 5, wherein
in the wiring binding step, the plurality of electric wires are fixed on the placement display in an overlapping manner on the image by using sucker-equipped clips.

8. The wire harness assembly work instruction method according to claim 5, wherein
in the wiring binding step, the components are fixed on the placement display in an overlapping manner on the image by using sucker-equipped pins.

9. A wire harness assembly work instruction method using the wire harness assembly work instruction device according to claim 3, the wire harness assembly work instruction method comprising:
an electric wire cutting step of cutting, at the wire length, each of the plurality of electric wires indicated by the electric wire type names, as displayed on the display unit;
a terminal preparing step of preparing a necessary number of terminals of the first connection destination and the second connection destination indicated by the product specification information storage unit, as displayed on the display unit;
a tool preparing step of preparing tools corresponding to connections between the terminals and the electric wires indicated by the electric wire type names, as displayed on the display unit;
a terminal connection step of making connections between the electric wires and the terminals by using the tools; and
a wiring binding step of laying the plurality of the electric wires to which the terminals have been attached, on the image displayed on the placement display, and binding the electric wires at a position displayed on the image.

10. A wire harness assembly work instruction method using the wire harness assembly work instruction device according to claim 4, the wire harness assembly work instruction method comprising:
an electric wire cutting step of cutting, at the wire length, each of the plurality of electric wires indicated by the electric wire type names, as displayed on the display unit;
a terminal preparing step of preparing a necessary number of terminals of the first connection destination and the second connection destination indicated by the product specification information storage unit, as displayed on the display unit;
a tool preparing step of preparing tools corresponding to connections between the terminals and the electric wires indicated by the electric wire type names, as displayed on the display unit;
a terminal connection step of making connections between the electric wires and the terminals by using the tools; and
a wiring binding step of laying the plurality of the electric wires to which the terminals have been attached, on the image displayed on the placement display, and binding the electric wires at a position displayed on the image.

11. The wire harness assembly work instruction method according to claim 9, further comprising, after the electric wire cutting step, a destination tube fitting step of causing the electric wires to be caught in an electric wire holder in the wiring order such that both ends of each electric wire are directed upward, and fitting, to the respective ends of each electric wire, tubes on which connection destinations of the ends are recorded.

12. The wire harness assembly work instruction method according to claim 10, further comprising, after the electric wire cutting step, a destination tube fitting step of causing the electric wires to be caught in an electric wire holder in the wiring order such that both ends of each electric wire are directed upward, and fitting, to the respective ends of each electric wire, tubes on which connection destinations of the ends are recorded.

13. The wire harness assembly work instruction method according to claim 9, wherein
in the wiring binding step, the plurality of electric wires are fixed on the placement display in an overlapping manner on the image by using sucker-equipped clips.

14. The wire harness assembly work instruction method according to claim 10, wherein
in the wiring binding step, the plurality of electric wires are fixed on the placement display in an overlapping manner on the image by using sucker-equipped clips.

15. The wire harness assembly work instruction method according to claim 11, wherein
in the wiring binding step, the plurality of electric wires are fixed on the placement display in an overlapping manner on the image by using sucker-equipped clips.

16. The wire harness assembly work instruction method according to claim 12, wherein
in the wiring binding step, the plurality of electric wires are fixed on the placement display in an overlapping manner on the image by using sucker-equipped clips.

17. The wire harness assembly work instruction method according to 9, wherein
in the wiring binding step, the components are fixed on the placement display in an overlapping manner on the image by using sucker-equipped pins.

18. The wire harness assembly work instruction method according to 10, wherein
in the wiring binding step, the components are fixed on the placement display in an overlapping manner on the image by using sucker-equipped pins.

19. The wire harness assembly work instruction method according to 11, wherein
in the wiring binding step, the components are fixed on the placement display in an overlapping manner on the image by using sucker-equipped pins.

20. The wire harness assembly work instruction method according to 12, wherein
in the wiring binding step, the components are fixed on the placement display in an overlapping manner on the image by using sucker-equipped pins.
